(19) United States
(12) Patent Application Publication
(10) Pub. No.: US 2009/0254477 A1
(43) Pub. Date: Oct. 8, 2009

(54) REVERSE FACTORING SYSTEM AND METHOD

(76) Inventor: Marc KRAMER, Philadelphia, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 12/062,157

(22) Filed: Apr. 3, 2008

(51) Int. Cl. G06Q 40/00

(52) U.S. Cl. 705/40

(57) ABSTRACT

The reverse factoring method and system provides an efficient and convenient way to process invoice payments from the buyer to its vendor via the factor. Since a single factor pays the vendor on behalf of the buyer at a nominal fee, both the buyer and the vendor benefit from the transactions. Both the vendor and the buyer enjoy better cash flow since the vendor receives expedited payments while the buyer stretches the payments. In addition, the factor substantially reduces the credit risks in reverse factoring since the factor pays only the invoices that the buyer approves for payment. The improved reverse factoring is achieved by efficient data flows and interfaces among the vendor, the buyer and the factor.

### FIELD OF THE INVENTION

The current invention is generally related to a financial software system and a business method, and more particularly related to a financial system for and a method of invoice payments involving reverse factoring.

### BACKGROUND OF THE INVENTION

Invoice payments by the buyers present a significant challenge for many sellers in small businesses. Since most buyers demand 30 to 90 days to pay after goods or services are delivered and sellers in small business do not generally have financing, these small businesses find it difficult to finance their next production or sales cycles. To facilitate financing, small businesses have availed themselves in factoring based upon their own invoices that are recorded for the buyer as an accounts payable and for the seller as an accounts receivable.

Traditional factoring involves the sales of accounts receivables. Since invoices may be considered as illiquid asset, the small businesses sell their credit-worthy accounts receivable to a factor at a discount that is equal to interest plus service fees. Thus, the small businesses receive from a factor immediate cash as working capital for the next production cycle before the invoices are paid by the buyers. Factoring is quite distinct from traditional forms of commercial lending where credit is primarily underwritten based on the value of the borrower's underlying assets as collateral.

Most factoring involves “without recourse.” That is, in non-recourse factoring, an invoice seller assumes no further risk since a factor assumes the credit risk for the buyer's ability to pay the invoice. Alternatively, factoring is arranged with recourse so that the factor makes a claim against the seller for any deficient payment from the buyer.

Some details of factoring involve a series of transactions among the seller, the buyer and the factor as depicted in The Role of Factoring for Financing Small and Medium Enterprises (WPS3593) by Leora Klapper, The World Bank. For example, the factor initially pays the seller up to 70% of the value of an accounts receivable or an invoice less certain predetermined interest and service fees. When the factor receives payment in full from the buyer, the factor subsequently pays the seller the remaining 30%. However, if the payment is not full from the buyer, the 30% reserve is used cover the deficiency. Thus, even in non-recourse factoring, the factor and the seller both share some risk together.

According to the World Bank, factoring has been used in countries around the world. In 2004, total worldwide factoring volume was over US$ 860 billion as the result of an impressive growth rate of 88% since 1998. Factoring has been utilized in developed economy such as in the United States as well as in developing economy. In fact, the World Bank points out that factoring may also be particularly important in financial systems with weak commercial laws and enforcement.

The above described factoring generally requires factors to perform financing, credit service and collection service. To finance, factors access the credit risk of factoring transactions based upon historical credit information, which is proprietary data and or publicly available data on account payment performance. Subsequently, factors attempt to collect delinquent accounts via notification or judicial enforcement.

In general, factoring has not been profitable in emerging markets. This is primarily because no good historical credit information is available for a large number of buyers in the emerging markets, and factors generally assume credit risk. Another reason is there is a large number of fraudulent accounts receivable that factors also have to assume high risk. To reduce risk of lenders, the factoring business needs improvement especially in emerging markets. Furthermore, factoring in developed countries is also improved by reducing similar risks and increasing efficiency.

One prior art approach has included reverse factoring to improve the above described problems. For example, The Role of “Reverse Factoring” in Supplier Financing of Small and Medium Sized Enterprises by Leora Klapper, The World Bank describes reverse factoring in general and a particular form as practiced in Mexico. In general, reverse factoring involves a seller, a buyer and a factor, and the factor purchases accounts receivables only from high-quality buyers at a predetermined discount rate. For example, the factor initially pays the seller 100% of the value of an accounts receivable or an invoice less certain predetermined interest and service fees. Subsequently, the factor receives payment in full from the buyer. However, if the payment is not full from the buyer, the factor generally assumes the liability for collection since most reverse factoring is without recourse.

One prior Mexican implementation includes the National Financiera (Nafin) development bank as a factor and multiple private banks as lenders/factors, which finance the invoice payments. In other words, the Mexican implementation allows the government to act as a clearing house agent so that the participating banks compete in reverse factoring receivables from large buyer companies primarily for small seller businesses. Thus, the seller selects a lending bank that offers the most favorable discount rate. Since the Mexican implementation involves multiple factors/lenders, the processing of the invoices at the buyer companies may be more complex than transactions involving a single factor. In addition, the clearing agent must generate more data and documents for tracking information on the multiple lenders. Thus, the benefit of competitive biding may be offset.

These and other issues associated with the Mexican government's implementation remain undesirable. For a private enterprise to be profitable in the reverse factoring business, efficiency needs to be improved in many aspects of the operation including transactions and marketing.

### SUMMARY OF THE INVENTION

In order to solve the above and other problems, according to a first aspect of the current invention, a method of reverse factoring in invoice payment includes the steps of: i) making an exclusive agreement between a buyer and a factor for offering reverse factoring transactions to all of the buyer's vendors; ii) soliciting the vendors to participate in the reverse factoring transactions; iii) paying from the factor to the vendor for invoices at a discount rate on behalf of the buyer if the vendor requests the factor to pay the invoices using the reverse factoring transactions; and iv) receiving from the buyer a full amount of each of the invoices that the factor has paid in the step iii) on behalf of the buyer.

According to a second aspect of the current invention, a method of reverse factoring in invoice payment, including the steps of: a) a vendor generating invoices each specifying a certain amount for services or goods delivered by the vendor to a buyer; b) the vendor sending the invoices to a factor and the buyer substantially at the same time; c) upon receiving approval for selected ones of the invoices from the buyer, the factor paying the vendor the approved invoices at a predetermined discount rate; and d) the factor receiving from the buyer a full amount of each of the invoices that the factor has paid on behalf of the buyer in the step c).

According to a third aspect of the current invention, a method of reverse factoring in invoice payment, including the steps of: A) a vendor generating invoices each specifying a certain amount for services or goods delivered by the vendor to a buyer; B) the vendor sending the invoices to a factor and the buyer substantially at the same time; C) the buyer selecting certain ones of the invoices for approval in reverse factoring; D) the buyer transmitting the factor information on the approved invoices; E) the factor paying the vendor without an external financing source the approved invoices at a predetermined discount rate; and F) the factor receiving from the buyer a full amount of each of the invoices that the factor has paid in the step E).

According to a fourth aspect of the current invention, a method of reverse factoring in invoice payment, including the steps of: a) a vendor generating invoices each specifying a certain amount for services or goods delivered by the vendor to a buyer; b) the vendor sending the invoices to a factor and the buyer; c) assuming approval of all of the invoices by the buyer, the factor paying the vendor all of the invoices at a predetermined discount rate; and d) the factor receiving from the buyer a full amount of each of the invoices that the factor has paid on behalf of the buyer in the step c).

According to a fifth aspect of the current invention, a method of reverse factoring in invoice payment, including the steps of: a) a vendor generating invoices each specifying a certain amount for services or goods delivered by the vendor to a buyer; b) the vendor sending the invoices to the buyer only; c) upon receiving approval for selected ones of the invoices from the buyer, a factor paying the vendor the approved invoices at a predetermined discount rate; and d) the factor receiving from the buyer a full amount of each of the invoices that the factor has paid on behalf of the buyer in the step c).

According to a sixth aspect of the current invention, a system for reverse factoring in invoice payment, including: a vendor system for generating invoice data for invoices and transmitting the invoice data; a buyer system connected to the vendor system for receiving the invoice data and processing the invoice data to generate payment approval data indicating approval of the invoices to be paid, the buyer system maintaining accounts payable based upon the invoices; and a factor system connected to the vendor system and the buyer system for receiving the invoice data from the vendor system and the payment approval data from the buyer system, the factor system selecting the invoices based upon the payment approval data for generating and transmitting payment instructions at a predetermined discount rate, the factor system updating information on a payee and a due date in the accounts payable of the buyer system upon confirming a payment according to the payment instructions.

According to a seventh aspect of the current invention, a system for reverse factoring in invoice payment, including: a vendor system for generating the invoice data for invoices; a buyer system connected to the vendor system for receiving the invoice data and processing the invoice data to generate payment approval data indicating approval of the invoices to be paid, the buyer system maintaining accounts payable based upon the invoices; and a factor system connected to the vendor system and the buyer system for receiving the invoice data from the vendor system and the payment approval data from the buyer system, the factor system selecting the invoices based upon the payment approval data for generating and transmitting payment instructions at a predetermined discount rate, the vendor system transmitting the invoice data to the buyer system and the factor system substantially at the same time.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a flow diagram illustrating an overview of activities in one preferred embodiment of the reverse factoring system or method according to the current invention.

FIG. 2 is a flow diagram illustrating certain initial activities in one preferred embodiment of the reverse factoring system or method according to the current invention.

FIG. 3 is a flow diagram illustrating certain activities associated with making payments to buyers in one preferred embodiment of the reverse factoring system or method according to the current invention.

FIG. 4 is a flow diagram illustrating certain activities associated with receiving payments from buyers in one preferred embodiment of the reverse factoring system or method according to the current invention.

FIG. 5 is a block diagram illustrating an example of a commercially available system for processing traditional factoring transactions that is used in one preferred embodiment of the reverse factoring system according to the current invention.

FIG. 6A is a flow chart illustrating steps involved in invoice processing in one preferred embodiment of the reverse factoring system according to the current invention.

FIG. 6B is a flow chart illustrating general steps involved in invoice payment in traditional factoring.

FIG. 7 is a flow chart illustrating steps involved in client interface in one preferred embodiment of the reverse factoring system according to the current invention.

FIG. 8 is a flow chart illustrating steps involved in client payment processing in one preferred embodiment of the reverse factoring system according to the current invention.

FIG. 9 is a block diagram illustrating data import in one preferred embodiment of the reverse factoring system according to the current invention.

FIG. 10 is a block diagram illustrating data export in one preferred embodiment of the reverse factoring system according to the current invention.

FIG. 11 is a block diagram illustrating data, lists and rules associated with buyers and vendors in one preferred embodiment of the reverse factoring system according to the current invention.

FIG. 12 is a block diagram illustrating reports in one preferred embodiment of the reverse factoring system according to the current invention.

FIG. 13 is a block diagram illustrating system environment setting and preferences in one preferred embodiment of the reverse factoring system according to the current invention.

Table 1 compares certain features between traditional factoring and reverse factoring according to the current invention.

### DETAILED DESCRIPTION OF THE PREFERRED EMBODIMENT(S)

In the following description, certain terms are interchangeably used as described here. The terms, “supplier,” “vendor” and “seller” are defined to be a first party who has sold goods and services to a second party and expects to receive payments from the second party who has received the sold goods and services. The terms, “purchaser,” “buyer,” “company” and “client” are defined to be the second party who has bought the goods and services and are expected to make payments to the “supplier,” “vendor” or “seller.” The term, “invoices” refers to electronic data or documents that are generated by the “supplier,” “vendor” or “seller,” and the “invoices” become a property of the “supplier,” “vendor” or “seller” as “accounts receivable” in the amount as specified by the invoices for the goods and services provided by the “supplier,” “vendor” or “seller” to the “purchaser,” “buyer,” “company” or “client.” In reverse factoring, a “factor” and a “reverse factor” are often interchangeably used and are a third party who makes a payment to the “supplier,” “vendor” or “seller for the “accounts receivable” at a predetermined discount rate on behalf of the “purchaser,” “buyer,” “company” or “client” and expects to be paid back in a full amount of the “invoices” from the “purchaser,” “buyer,” “company” or “client” within a certain predetermined time period.

The current invention is directed to a business method and a computer system of storing and updating information associated with buyers, sellers and factors in reverse factoring of invoices. In general, the factors pay a discounted amount of accounts payables or invoices to the sellers on behalf of the buyers in reverse factoring and are paid back in full by the buyers. In effect, factors make an arrangement to pay accounts payables directly with the buyers in reverse factoring rather than with the sellers to pay their accounts receivables in traditional factoring. Although the buyers in reverse factoring are generally well-known high-quality large organizations, the current invention is not limited to any particular size of organizations. As opposed to the credit risk of the sellers in traditional factoring, the factors face the credit risk that is substantially equal to the default risk of the buyers in reverse factoring. Although it depends upon the quality of the buyers, the factors could substantially eliminate unknown credit risks of small unknown sellers in reverse factoring.

Furthermore, reverse factoring benefits sellers. Once an invoice is approved by the buyers, the sellers are paid nearly 100% of the invoices rather than around 70% in traditional factoring. Thus, the expedited payments substantially improve the sellers' cash flow with minimal fees. At the same time, sellers are not required to submit any credit information on the buyers who participate in the approved reverse factoring program. In contrast, factors in traditional factoring often require additional documentations such as federal and state tax returns, loan agreements, incorporation papers, employment tax receipts, all sales contracts and audited financial statements. In addition, since the credit risk is generally lowered in reverse factoring transactions, the factors may advance a larger amount to the sellers through reverse factoring than traditional factoring. Lastly, since most reverse factoring arrangements are without recourse, the participating sellers are also free from collateral or personal guarantees.

Similarly, reverse factoring also benefits buyers. In general, the buyers can stretch the time to pay their accounts payable substantially at the sellers' expense until the buyers are due for payment to the factor. Since the sellers are paid at a discount rate or in a less than a full value, the sellers are largely paying for the services provided by the factors. However, depending upon an arrangement with a factor, the buyers may also have to share the fees associated with the reverse factoring services. Other benefits to the buyer companies include that they do not have to expend their own resources in managing accounts payables to maintain a certain level of cash flow. The buyers also save their resources to respond to their vendors' inquiries for maintaining good relations since timely invoice payments substantially reduce these inquiries. Because of the consistent timely payments, the company's credit rating may be improved and the vendors may also offer better pricing.

One preferred embodiment of the reverse factoring system according to the current invention improves the factor's operation. A preferred embodiment is targeted at the companies (buyers) with the best credit who hold a substantial number of invoices for 40 to 60 days. Preferably, the factor obtains an exclusive arrangement to offer funding services to all of the targeted company's vendors (sellers). Although the current invention is not limited to the above described clientele, the exclusive arrangement for offering reverse factoring opportunities to all of the client's vendors is essential in improving the factor's cost of doing business. The exclusive arrangements efficiently increase a number of reverse factoring transactions to generate fees. Furthermore, since the exclusive arrangements could substantially save sales and marketing costs in recruiting vendors, they ultimately lead to competitive pricing. To attract the vendor participation, one preferred embodiment of the reverse factoring system pays the vendor on the same business day of approval by the buyer.

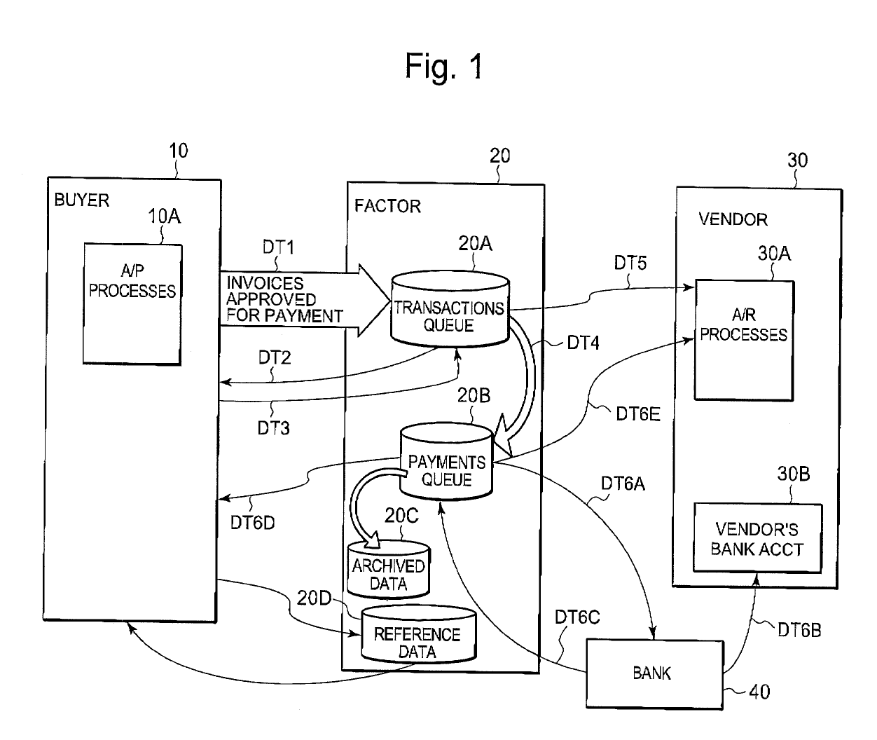

Referring now to the drawings, wherein like reference numerals designate corresponding structures throughout the views, and referring in particular to FIG. 1, one preferred embodiment of the reverse factoring system according to the current invention includes a buyer's system 10, a factor's system 20 and a vendor's system 30. The systems 10, 20 and 30 each have their own computer network using LAN, WAN and Wi-Fi technologies, and the systems 10, 20 and 30 are also connected with each other via public and or private communication lines. Although FIG. 1 illustrates only one buyer's system and one vendor's system, the factor system 20 is optionally connected to a plurality of other selected buyer and vendor systems at the same time according to one preferred embodiment of the current invention. In one preferred embodiment, the buyer system 10 and the vendor's system 30 further include computer hardware and software to respectively support accounts payable (A/P) processes 10A and accounts receivable (A/R) processes 30A. Similarly, the factor system 20 also further include computer hardware and software to maintain various information such as transactions queue 20A, payment queue 20B, archived data 20C and reference data 20D. In general, for the services and or goods delivered to the buyer, the vendor system 30 generates the corresponding invoice data in the A/R processes 30A, and the A/P processes 10A in the buyer system 10 and the transactions queue 20A of the factor system 20 each receive the invoice data in order to process the future payments through reverse factoring.

The flow diagram of FIG. 1 illustrates an overview of additional activities in reverse factoring according to the current invention following the above described invoice data generations and transmissions. The transactions queue 20A of the factor system 20 now receives an interface file containing invoice approval data from the buyer system 10 via data transmission DT1. The invoice approval data indicates which ones of the invoices from the vendor system 30 have been approved for payment and which other ones have been denied for payment. Alternatively or in combination, an operator of the buyer system 10 manually retrieves the invoice data from the transactions queue 20A of the factor system 20 through secure Web-based interface as indicated by an arrow DT2 and sends approval data for selected ones of the invoices as indicated by an arrow DT3.

In response to either of the above described invoice approval data, the factor system 20 now generates payment data and transmits it to the payment queue 20B as indicated by an arrow DT4. The factor system 20 also transmits a pending payment message to the vendor system 30 as indicated by an arrow DT5 to inform the vendor system of the future payments for the pending invoices. At the same time, upon confirming the payment data in the payment queue 20B, the factor system 20 transmits payment instructions to a predetermined bank 40 as indicated by an arrow DT6A for making a payment to a vendor's bank account 30B via a predetermined manner such as wire and ACH as indicated by an arrow DT6B. After the factor 20 receives a payment confirmation from the bank 40 as indicated by an arrow DT6C, the factor 20 confirms that the requested invoices have been paid via payment advice to the buyer system 10 and the vendor system 30 as respectively indicated by arrows DT6D and DTC 6E. Concurrently, the payment advice updates the A/P processes 10A and the A/R processes 30A.

Still referring to FIG. 1, the overview illustrates the above described reverse factoring activities involving the buyer, the factor and the vendor, and these activities are reflected in the information stored in the buyer system 10, the factor system 20 and the vendor system 30. The buyer, the factor and the vendor are only actors or participating parties in the reverse factoring transactions according to the current invention. It should be clearly noted that the bank 40 is merely an agent of the factor and is not a direct participant in reverse factoring according to the current invention. In other words, the bank 40 in the current invention is not a participating lender as in the prior art Mexican implementation of reverse factoring since the factor itself finances the payments to the vendors in the current invention.

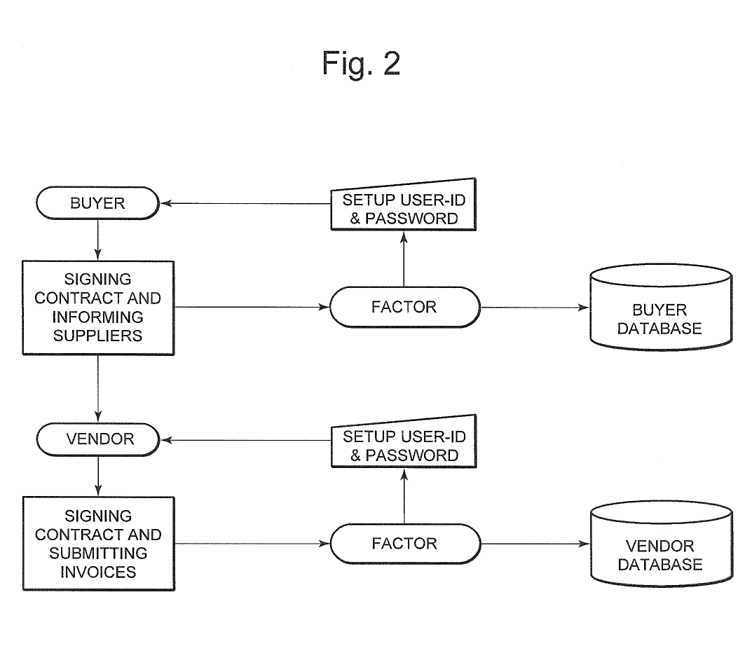

Now referring to FIG. 2, certain initial steps are illustrated in establishing a predetermined arrangement among the buyers, the vendors and the factor prior to the above described reverse factoring transactions according to the current invention. The factor and the buyer agree to a contract for offering the above described reverse factoring services. Although the detailed of terms and conditions of the contract depend upon the parties, the contract in general provides that the buyer pays back 100% value of the invoices within a certain specified time period after the factor has advanced to the vendors at a discount rate. In addition, the buyer may agree to certain fees associated with the service. Preferably, the contract is exclusive that the buyer agrees to offer the factor all potential reverse factoring transactions with its vendors. However, the contract is not limited to an exclusive arrangement, and the buyer may allow only selected vendors for participation.

Furthermore, the contract also calls for certain other obligations in relation to the computer systems. The buyer's computer system is available and can interface with the factor's computer system so that the associated reverse factoring transactions are carried out via computers without substantially modifying the factor's computer system. Upon signing the contract, the factor sets up an account in the buyer database of the factor's computer system and provides the buyer with access information such as user identification and a password.

Still referring to FIG. 2, the participating buyer now informs its vendors of their opportunities for receiving invoice payments from the factor in an expedited manner via reverse factoring. In general, the participating buyer is motivated to encourage its vendors to take advantage of the reverse factoring transactions since the buyer benefits by improving its own cash flow due to the delayed accounts payable at the vendor's costs. In addition, a certain arrangement may be made so that the factor also promotes the reverse factoring transactions with the vendors. In fact, when a vendor participates in the reverse factoring arrangement, a vendor also agrees to a separate contract with the factor for certain terms including a discount rate for the invoice payment and or a monthly fee. In general, the vendor may select any number of the invoices for reverse factoring unless the factor and the vendor agree in advance for a different arrangement. Upon signing the contract, the factor sets up an account in the vendor database of the factor's computer system and provides the vendor with access information such as user identification and a password.

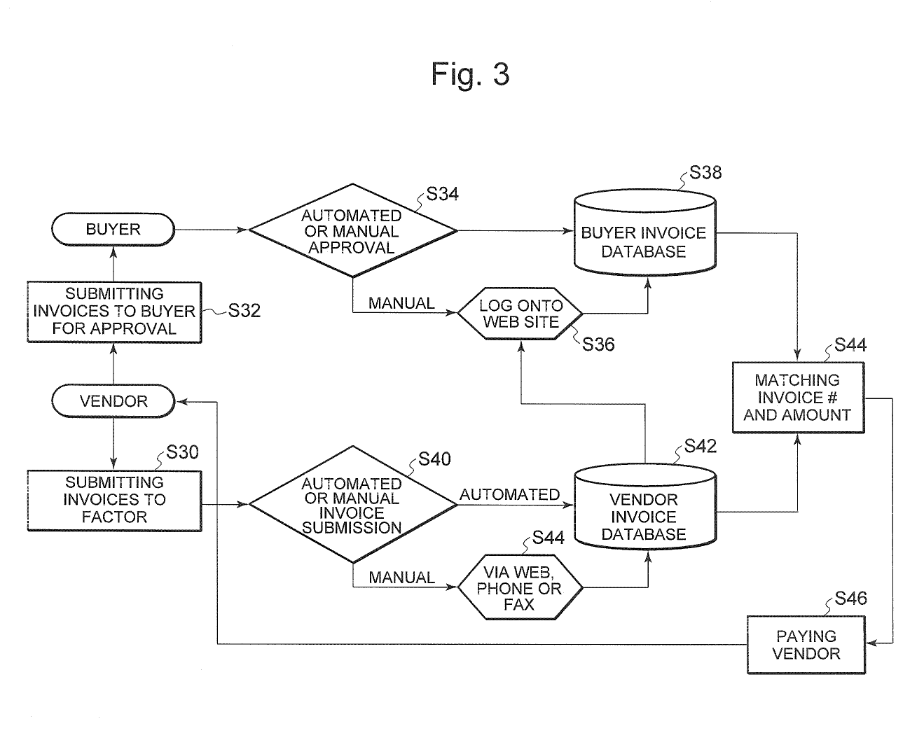

Now referring to FIG. 3, some detailed steps of the invoice payment are illustrated in one preferred embodiment of the reverse factoring system according to the current invention. As already described with respect to FIG. 1, a participating vendor submits selected invoices both to the buyer and the factor respectively in steps S30 and S32 for invoice payment based upon reverse factoring. The steps S30 and S32 may be simultaneous or substantially at the same time. Alternatively, the step S32 to the buyer takes place before the step S30 since it takes the buyer some time to process for approval.

Upon receiving the invoice data, the buyer determines a method to process the invoices either automatically or manually as indicated in a step S34. If they are manually processed, an authorized person of the buyer company logs onto a predetermined Web site in a step S36 where he or she accesses the buyer invoice database of the factor's computer system and indicates each of the submitted invoices to be approved or denied for payment by the factor. On the other hand, if they are automatically processed, the buyer's computer system designates all of the submitted invoices in the buyer invoice database to be paid by the factor via an interface file in a step S38. For a plurality of participating vendors, the above described steps are repeated for each of the vendors. Alternatively, the buyer's computer system may be implemented to designate the submitted invoices from all its vendors to be approved for payment by the factor based upon a certain predetermined condition such as aging.

Still referring to FIG. 3, the factor may receive the invoice submission in various manners from the vendor. Upon receiving a submission request, the factor determines whether or not the invoice submission is processed automatically in a step S40. If it is automatically processed, the submitted invoice data is processed and stored in the vendor invoice database of the factor's computer system in a step S42. Although electronic invoice submission is most efficient, in case of a small number of the invoices, the vendor may have options for indicating such invoices for reverse factoring as indicated in a step S44. For example, an authorized person of the vendor company logs onto a predetermined Web site where he or she manually enters a predetermined set of invoice information for payment by the factor. Other examples of the manual submission include the same invoice information by telephone, fax or e-mail. A data entry person at the factor company enters by hand the manually submitted information into the vendor invoice database of the factor's computer system in the step S42. Upon completing the invoice submission request from the vendor in the step S42, the factor optionally transmits a notice such as e-mail to the buyer for the pending invoices that await approval from the buyer.

Lastly, FIG. 3 illustrates final steps of making a payment for the approved invoices to the vendor in the preferred embodiment according to the current invention. After the submitted invoice data is in the vendor invoice database of the factor's computer system, when the buyer transmits the approval information on the invoices, the factor's computer system simply selects in a step S44 the approved invoices from the vendor invoice database based upon an invoice number and its invoice amount. Subsequently, the factor's computer system generates payment instructions for the approved invoices and transmits them to a proper agent such as a bank in a step S46. For example, in case of a wire transfer, the payment instructions are transmitted to a predetermined bank so that the specified amount is deposited into a vendor's bank account. It should be noted that the above specified payment amount in the payment instructions is less a full value of the corresponding invoices since the invoices are paid at a predetermined discounted rate according to a contract between the factor and the participating vendor.

There are alternative embodiments to the above preferred embodiment of the reverse factoring system or method according to the current invention. In one alternative embodiment, the buyer does not have to provide approvals in either a manual or automated form. Instead, all invoices will be assumed to be approved immediately (assumed approvals). All previously submitted vendor invoices are downloaded in an Approval Interface file into the factor's system, and each invoice is assumed to be approved. There will be no denials for the submitted invoices. The advantage is that there will be no gaps between invoice submissions and approvals except for the time it takes to process batches. On the other hand, the disadvantage is that disputes could arise afterwards for the assumed approvals. This alternative embodiment may be used only for those buyers who have already determined that they have few disputes with their vendors and have created a separate process that excludes the factor so as to mitigate the risk to the factor.

Unlike the above described Assumed Approvals approach where the buyer does not submit any data to the factor, a second alternative embodiment allows the vendors to submit invoices only once to the buyer (No Vendor Submissions). This process assumes that all invoices are submitted to the factor only after buyer's approval. Again, there will be no denials submitted. When an invoice is approved, the factor will receive it for the first time as part of the file verification process. Since there is no vendor invoice database to match against in the factor system, the factor will create a new batch process to automatically “replicate” the buyer's approval file in the factor system. One major advantage is that as no vendor input is required to the factor's system, the vendor avoids duplication of effort. That is, an invoice is only sent by the vendor to the buyer and not as a separate and duplicate record to the factor.

In a third alternative embodiment of the current invention, the factor handles all or most of the buyer's payables, not just the ones to be expedited via reverse factoring. One advantage is that the buyers would streamline their AP process and lower their cost per invoice. More importantly, the visibility of spend would not be affected in any way as there would be just one source for all payments. In this alternative embodiment, the buyer agrees that it must transfer funds to the factor before normal funding requests are paid. To implement this alternative embodiment, the factor will need to modify its process so that it can easily determine which invoice submissions are for immediate or normal payments. For immediate payments, the factor pays via reverse factoring on the same or next business day as described above. On the other hand, for normal payments, the factor pays within a predetermined range from 45 to 60 days per the buyer's standard operating procedures. When the vendors enter or upload invoices in the third alternative embodiment, they will have to provide at least one more data element indicating a funding choice. The buyer will still need to submit approvals to the factor in manual or an automated form. The factor will not pay any invoices regardless of the immediate or normal options unless they are first approved by the buyer. Once approved, the factor will need to create a process to “stack and age” all normal requests for payment.

In a fourth alternative embodiment of the current invention, the buyer uses the factor's system to extend their payables, but at the same time, expedite payments from their customers for their own receivables. That is, the same buyer also participates in the reverse factoring program according to the current invention as a vendor. To implement, the buyer and each of their participating vendors must be set up in the factor's system, and the factor also needs to contact the buyer's customers to see if they wish to participate in this process as well. Their customers, if interested, would then be entered in the system as buyers and linked back to the original buyer (now a vendor) for approvals.

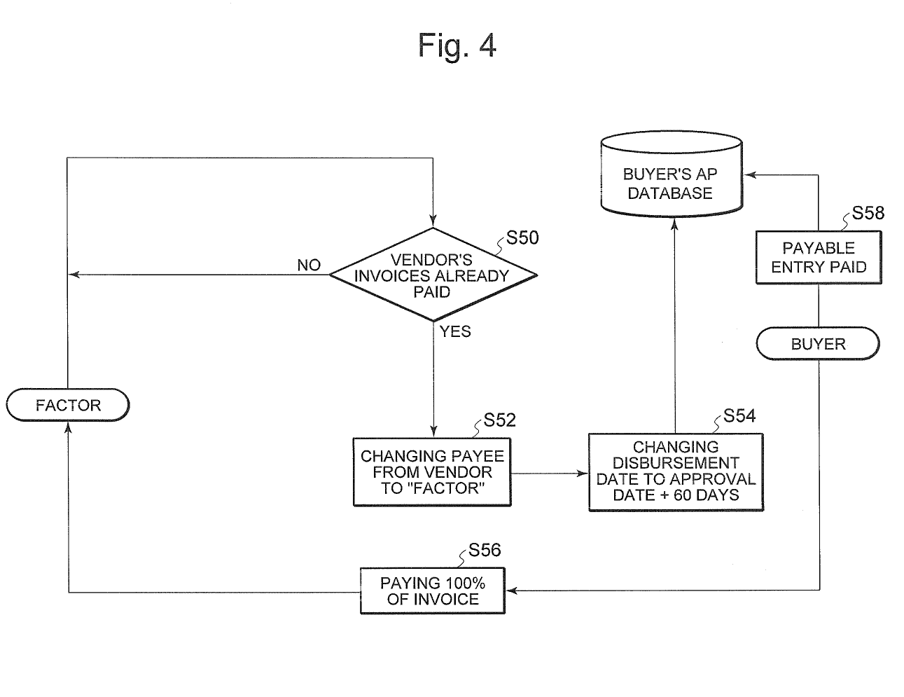

FIG. 4 illustrates some detailed steps by the factor and the buyer after the invoice payments have been made to the vendors according to the current invention. In a step S50, the factor determines whether or not a particular invoice that has been requested for reverse factoring has been already paid to the vendor. If it has not been paid to the vendor according to the lack of payment advice from a bank, the factor will make sure the funds are transmitted immediately. On the other hand, if it is determined in the step S50 that the invoice has been paid to the vendor according to payment advice from a bank, the factor in a step S52 transmits to the buyer's computer system certain data indicating that the payee information for the invoice should be changed to the factor in the buyer's accounts payable (AP) database. In addition, the disbursement due date to the factor should be also changed to over 60 days from the approval date by the buyer for the invoice in a step S54. These two steps may be combined into a single step in computer implementation.

Still referring to FIG. 4, the buyer performs its contractual obligation for the reverse factoring arrangement by making a disbursement to the factor within a specified time. In a step S56, the buyer pays a full amount of the invoice that has been already paid to the vendor by the factor. Although exact terms and conditions for the disbursement are defined in the contract that the parties have agreed, as illustrated in this preferred embodiment, the buyer generally pays 100% of the invoice amount to the factor so that the factor's profit is secured at least by the difference between the full invoice amount and the discounted invoice amount paid to the vendor. As previously described, the factor's profit may originate from some additional fees from the buyer and or the vendor as agreed in the contract. Finally, after the full disbursement to the factor, the buyer enters the payment record for the corresponding invoice in its accounts receivable database in a step S58.

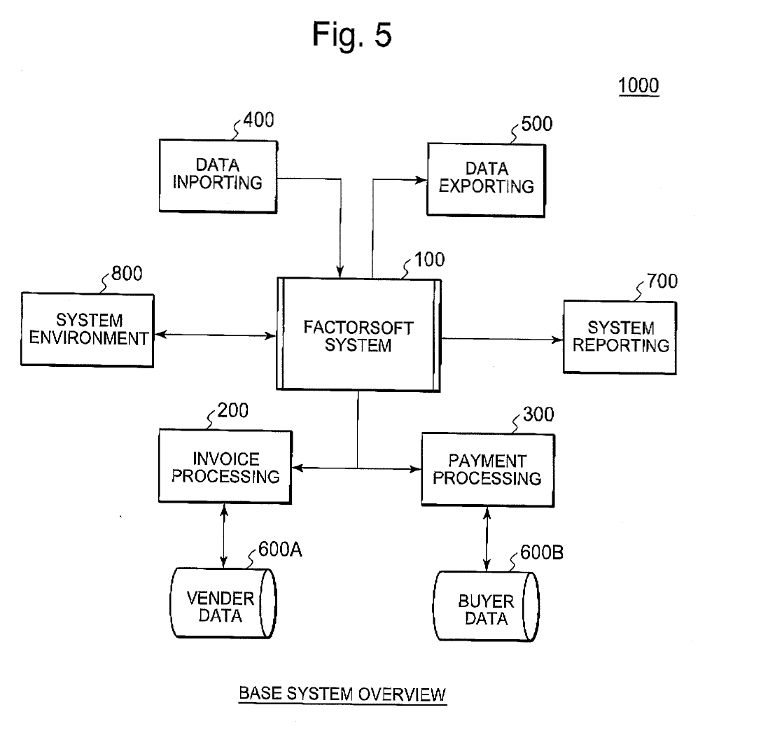

Now referring to FIG. 5, a block diagram illustrates a base system overview of a certain commercially available software system called, FactorSoft, Topanga, Calif. (www.factorsoft.com) for processing traditional factoring transactions. Since FactorSoft is designed to process traditional factoring transactions, the preferred embodiment for the reverse factoring system further includes additional modules and interfaces for processing reverse transactions according to the current invention. One preferred embodiment 1000 of the reverse factoring system according to the current invention is thus implemented with certain functionality of FactorSoft system 100. The preferred embodiment 1000 further includes an invoice processing module 200 with vendor data 600A, a payment processing module 300 with buyer data 600B, a data importing module 400, a data exporting module 500, a system reporting module 700 and a system environment module 800. The reverse factoring system according to the current invention is not limited to the use of any particular commercially available software system such as FactorSoft and may be implemented by other software and or dedicated hardware.

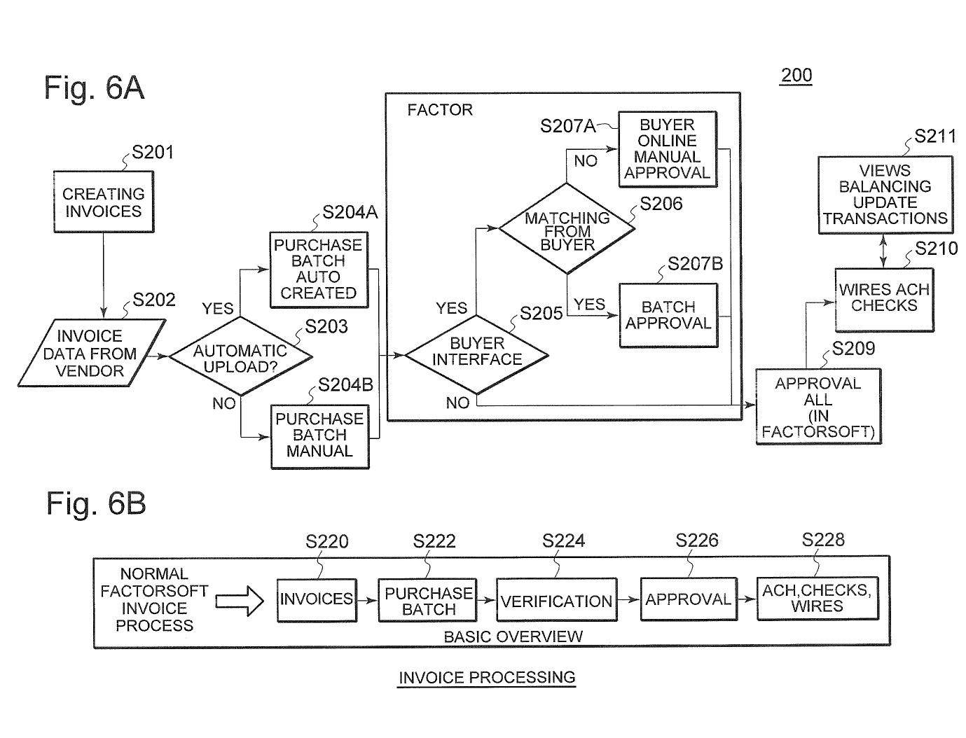

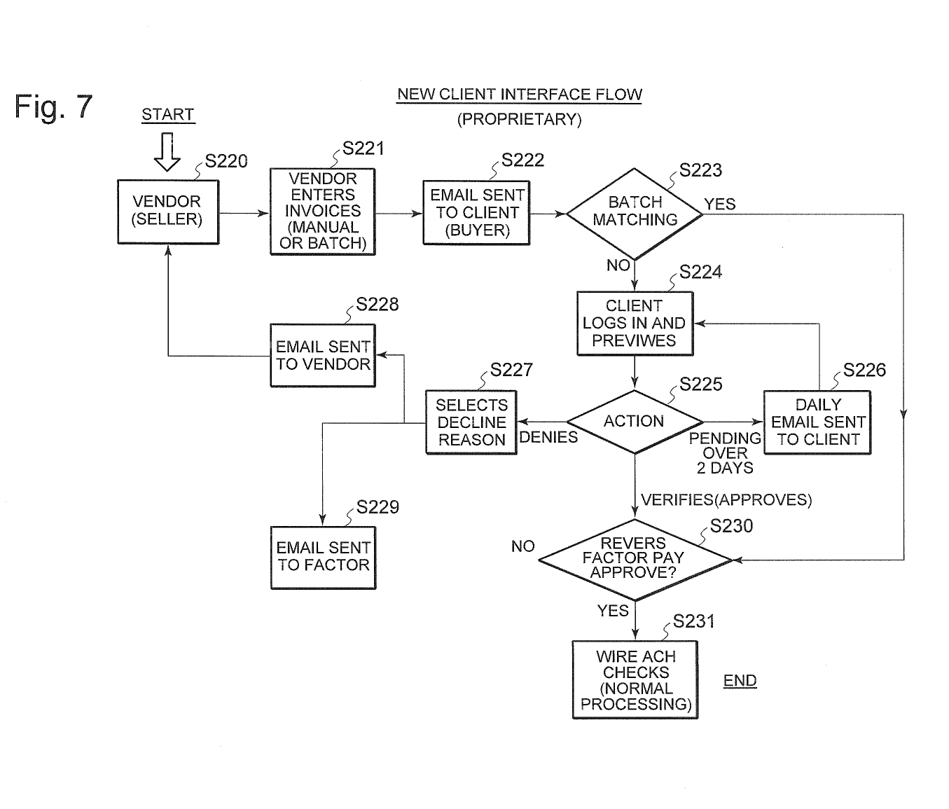

Now referring to FIG. 6A, a diagram illustrates some components of the invoice processing module 200 and associated steps performed by one preferred embodiment of the reverse factoring system according to the current invention. The invoice processing involves multiple steps performed by the vendor, the buyer and the factor in a predetermined manner. The invoice processing is generally initiated when a participating vendor generates invoice data 202 to be processed for reverse factoring in a step S201. The vendor then selects a way to upload the invoice data to the factor in a step S203. If the vendor selects an automatic upload, a certain predetermined set of invoice information is extracted from the generated invoice data 202 in a step S204A. For example, the automatically created purchase batch includes four or five elements of information per invoice such as an invoice number, a purchase order number, an invoice date, a buyer account number and an invoice amount. On the other hand, if the vendor selects a manual upload, a similar set of information is manually entered in a step S204B. Either case, a predetermined set of invoice information is uploaded to the factor's system for processing each invoice for the reverse factoring transactions.

Still referring to FIG. 6A, steps inside a box labeled “Factor” indicate certain features of reverse factoring according to the current invention. Accordingly, these steps are not supported by commercially available prior art systems such as FactorSoft. One preferred embodiment of the current invention provides a flexible and efficient buyer interface with the factor's computer system so that the buyer indicates its approval or rejection for invoice payment through reverse factoring. If the buyer selects to use the interface in a step S205, the buyer has a further option of using automatic or manual approval in a step S206. When the buyer sends to the factor's system an interface file containing information indicating approval/denial for the invoices that have been already submitted by the vendor, the interface in a step S207B automatically selects only approved invoices from the uploaded invoices at the factor's system. Alternatively, the buyer logs onto a secure Web-site in a step 207A in order to manually approve the uploaded invoices in the factor's computer. Lastly, when either of the above interfaces is not used, the buyer can still provide the factor's computer system with relevant information individually identifying approval or rejection of the invoices through other means.

Upon confirming the approved invoices in a step S209, the factor system prepares the payment instructions in a step S210, and the payments can be made to the buyer via check, wire or ACH according to a predetermined arrangement. The payment amount is less than a full invoice amount since the difference is at least a part of a fee for the reverse factoring service. Although the discount rate is generally about 5%, the parties may agree to other rates and or fee structures. At the end of the invoice processing, the factor's system updates the pending invoice status. Both the participating buyer and vendor are able to confirm the reverse factoring transactions by accessing the corresponding on-line record in a step S211.

Now referring to FIG. 6B, a general invoice payment in a traditional factoring process is illustrated and is compared to the above described reverse factoring invoice payment process. In a traditional factoring, a vendor also generates invoices in a step S220. Without involving a buyer, a factor purchases these invoices in a step S222 and independently verifies these invoices in a step S224 based upon the information that the vendor is required to provide the factor. If the factor approves the payment of the verified invoices in a step S226, the factor generally pays around 70% of an invoice amount minus a certain transaction fee in a step S228 via a predetermined manner such as ACH, check or wire. Although the diagram lacks additional steps, after the factor receives a full payment from the buyer, the factor pays the remainder of the invoice amount to the vendor. In addition, FIG. 6B also fails to explain that the factor faces a substantial credit risk in a traditional factoring process because the factor does not necessarily have a past relation with the buyer or the buyer does not have any contractual obligation with the factor.

Table 1 supplements some additional information for the above comparison between traditional factoring and reverse factoring systems according to the current invention. In this table, the exemplary data is provided as practiced by Prompt Payment, LLC as a reverse factor. As already partially described, a factor in reverse factoring initially pays the invoice at 100% of its value minus a predetermined fee on the same day while a factor in traditional factoring initially pays from 70% to 80% of its value minus a predetermined fee most unlikely on the same day and reserves the remaining 30% until a full payment from the buyer. The average monthly fee for traditional factoring and reverse factoring is respectively 3% and no charge. While traditional factoring generally requires a minimal invoice amount of $100 and often a minimal number of monthly invoices, reverse factoring by Prompt Payment has a range of $100 to $1,000 for a minimal invoice amount depending on a buyer but without a minimal number of monthly invoices. Furthermore, traditional factoring generally requires periodic interest charges vs late fees, recourse, full charge backs, lockbox, a first lien position, and even personal guarantees on certain occasions. In contrast, Prompt Payment requires none of these obligations. The fee structures in traditional factoring often incur additional costs such as credit insurance fees, credit collection fees, accounts receivable management fees, directed letters fees and vendor guarantees fees to the vendor. Most reverse factoring arrangements do not require the vendor to guarantee any of these fees. Lastly, traditional factoring does not require that a buyer guarantees its fee while Prompt Payment requires it. Although there may be some variations to the above specified obligations and fees, reverse factoring is generally more economical to the vendors than traditional factoring.

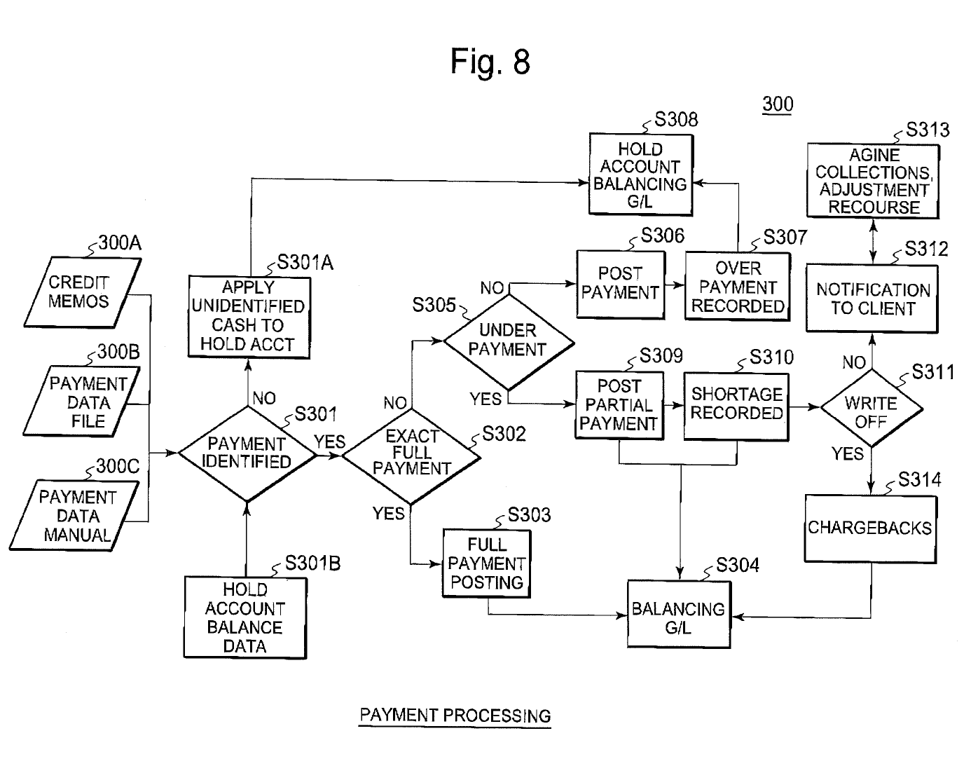

Now referring to FIG. 7, a flow chart further illustrates some additional steps involved in the invoice payment process according to the current invention. The vendor generates invoices in a step S220 to be paid through reverse factoring and enters in a step S221 these invoice data into the factor's computer system as well as the buyer's computer system in a manual or batch mode. As described above, if a number of the invoices is limited, a manual entry may be made using a predetermined on-line facility or the like. On the other hand, if a large number of invoices is involved, a batch mode is efficient by electronically transmitting a predetermined set of information for each of the invoices in a single interface file. After the above uploading step S221, a notice such as e-mail is sent to the buyer in a step S222 so that the buyer initiates an approval process.

Still referring to FIG. 7, upon receiving the notice, the buyer processes the invoice payment request through reverse factoring according to the current invention. In case of a plurality of the invoices, the buyer determines in a step S223 whether or not all of the invoices are approved. If the buyer determines to review an individual invoice in the step S223, the buyer securely logs in at a predetermined Web-site using a user ID and a password in a step S224. For each invoice, the buyer determines to take a certain action including denying, approving or no action in a step S225. If the buyer denies an invoice for payment through reverse factoring, the buyer optionally selects a reason in a step S227, and a notice such as e-mail is sent to the vendor and the factor respectively in steps S228 and S229. If no action is taken for an invoice and the invoice has been pending for more than 3-5 business days, a notice is automatically generated and transmitted to the buyer's computer system so that the buyer is later reminded of making a decision in a step S226. Lastly, if an individual invoice or an entire set of the invoices is approved, the factor is provided with the approval data indicating which invoices are ready to be paid. Subsequently, the factor initiates an invoice payment based upon the approval data from the buyer, and the factor prepares payment instructions in a step of S231.

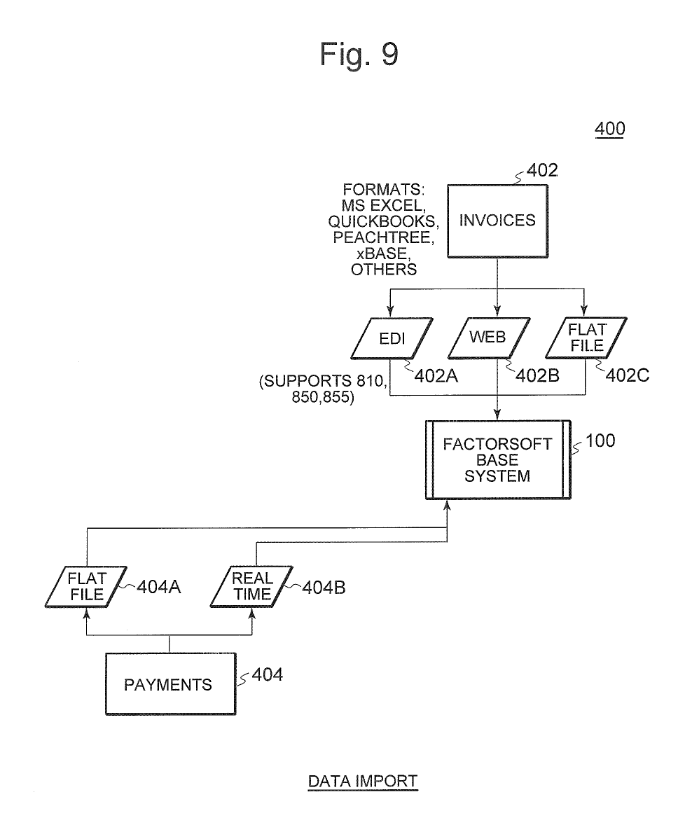

Now referring to FIG. 8, a flow diagram illustrates steps involved in a disbursement process by the buyer to the factor in reverse factoring according to the current invention. Since the buyer is also a client of the factor as defined in the current specification, the disbursement process is also referred to as client payment processing. After certain approved invoices have been paid to the vendor on behalf of the buyer, the buyer is now contractually obligated to pay back a full value of the invoices to the factor. The payment is made in predetermined forms including credit memos as in a step S300A or deposits into the factor's account. Subsequently, the buyer transmits the corresponding data in an electronic file in a step S300B or manually enters the payment data at a predetermined secure Web site in a step S300C. In addition, previously unresolved payment information 301B is also applied to the current client payment processing.

Upon receiving the payment information, the factor identifies a corresponding accounts receivable entry for the invoice payment in a step S301. If no corresponding invoice payment is identified in the step S301, the unidentified amount is applied to a predetermined hold account in a step S301A, and the general ledger (G/L) is balanced in a step S308. On the other hand, if a corresponding invoice payment is identified in the step S301, it is further determined whether or not the identified amount is an exact full payment in a step S302. If it is not an exact full payment, it is further determined in a step S305 whether or not the amount is an underpayment. In case of an underpayment, the underpayment amount is posted for the invoice in a step S309, and the balance is recorded in a step S310. In addition, the client payment process further determines whether or not the balance is written off in a step S311. If the balance is not going to be written off, the factor's system sends a notice to the buyer for the balance in a step S312, and any further action such as collection, adjustment and or recourse is considered in a step S313. On the other hand, if the balance is written off, the amount is charged back in a step S314 and an appropriate G/L is balanced in a step S304. If it is determined in the step S305 that the payment amount is an overpayment, an exact amount is posted for payment in a step S306. The client payment process also records an overpayment portion as credit in a step S307 and balances an appropriate G/L account. Lastly, only when an exact full payment is made for an identified reverse factoring transaction, a full payment is posted in a step S303 and an appropriate G/L account is balanced in the step S304.

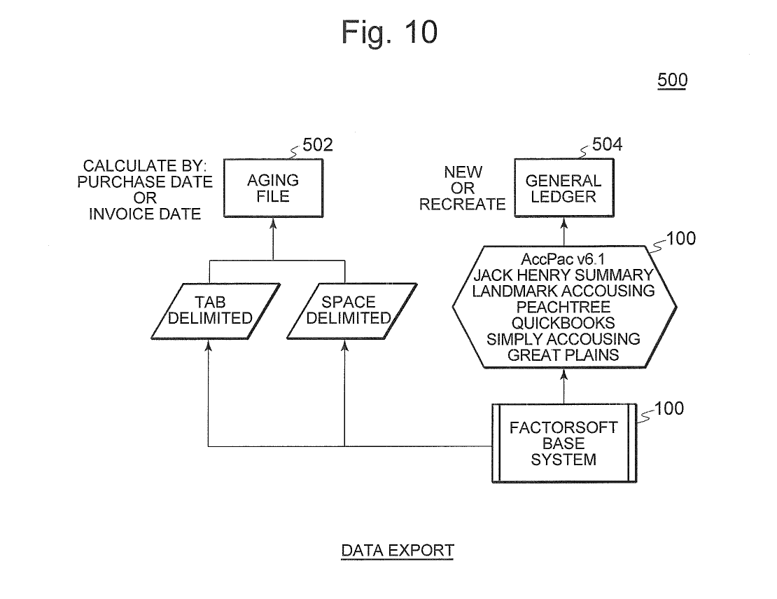

Now referring to FIG. 9, a flow diagram illustrates some detail of data import 400 with respect to the already described invoice processing and client payment processing in the reverse factoring system according to the current invention. With respect to the invoice processing, FIGS. 6A and 7 illustrate the use of a Web site and an interface file to upload the invoice data to be used for the reverse factoring transactions. The vendor's system generates invoice data 402 in certain formats using commercially available software such as Microsoft Excel, QuickBooks, Peachtree, xBase and so on. Alternatively, the vendor can generate an invoice data file using commas as a delimiter for a certain predetermined set of information or certain Electronic Data Interchange (EDI) formats 402A. Some of these flat files 402C are directly uploaded to the FactorSoft base system 100. In lieu of uploading an electronic file, the vendor can upload the invoice information via a Web site 402B. Lastly, the invoice data is also indirectly entered into the FactorSoft base system 100 via some other means such as e-mail and fax.

By the same token, with respect to the client payment processing, FIG. 9 illustrates the use of an interface file in data import to upload the invoice payment data to be processed for settling the reverse factoring transactions. The buyer's system generates invoice payment data 404 in certain formats using commas or semicolons as a delimiter for a predetermined set of information. The invoice payment data includes only the data, parallel data with images associated with the payments or serial data with images associated with the payments. The images in remittance advices in the PDF format may be used to search for certain patterns and to parse the invoices. Alternatively, the buyer can process invoice payments on real time 404B via the FactorSoft base system 100.

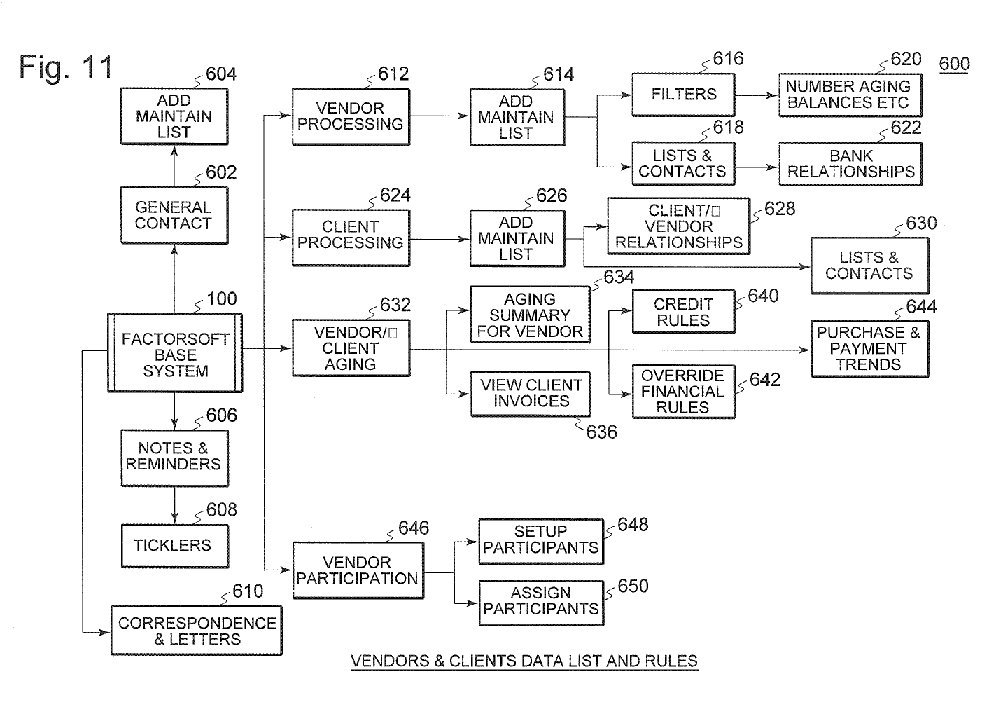

Now referring to FIG. 10, a diagram illustrates certain data export features in the reverse factoring system according to the current invention. The factor may run certain reports and export the data for internal reporting. For example, one preferred embodiment using the FactorSoft 100 exports data to commercially available software such as PeachTree, QuickBooks, Simply Accounting and Great Plains so that general ledger 504 of the factor is updated or generated. Subsequently, a daily transaction summary is internally reported based upon the general ledger. The FactorSoft 100 also exports data to generate an aging file 502 for further analyses of the reverse factoring operation according to the current invention. The aging file 502 may be either tab delimited or space delimited. The aging file 502 may be sent to the buyer as a certain form of notification for unprocessed pending invoices that have been uploaded by the vendor, but have not been paid.

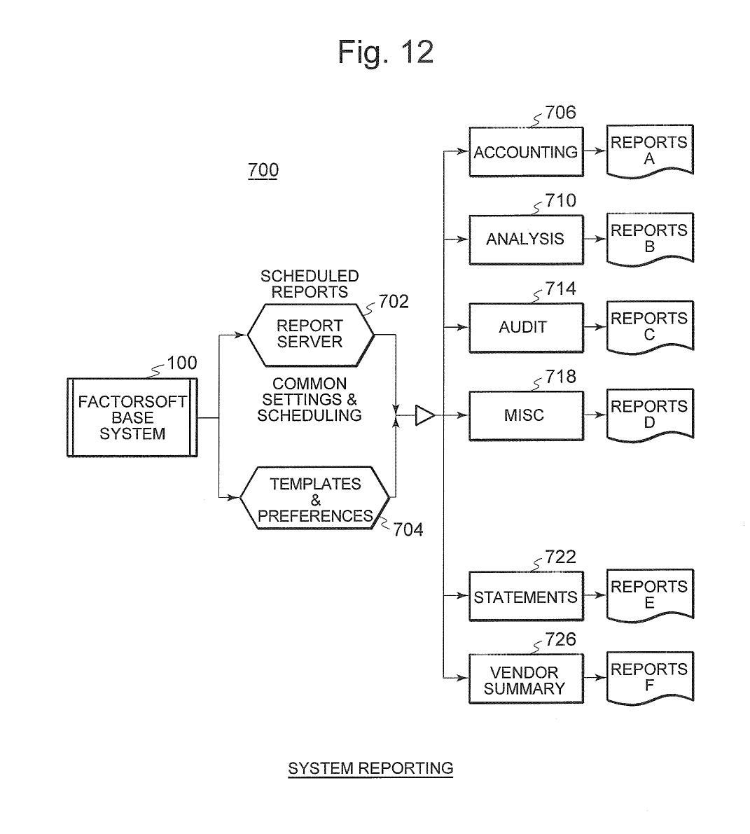

FIG. 11 illustrates certain data, lists and rules 600 that are used in the reverse factoring system according to the current invention. One preferred embodiment using the FactorSoft 100 maintains general contact list 602 containing information on contacts, potential participating buyers and vendors. A separate and additional general contact list 604 may be generated and maintained. One preferred embodiment using the FactorSoft 100 also maintains notes and reminders 606 in relation to the reverse factoring operation, and these notes and reminders may be presented as ticklers 608 as necessary. Similarly, one preferred embodiment using the FactorSoft 100 maintains letters/correspondence 610 in relation to the reverse factoring operation. For vendor related processing 612, the preferred embodiment using the FactorSoft 100 includes a list of vendors 618 that is maintained in a maintenance unit 614. An information filter 616 may be used to generate certain information 620 such as transaction numbers, aging and balance for a selected vendor. Similarly, for client related processing 624, the preferred embodiment using the FactorSoft 100 includes a list of clients 630 that is maintained in a maintenance unit 626. The client list 630 also includes client/vendor relationships 628. For the vendor/client aging process 632, the preferred embodiment generates an aging summary for the vendors 634 and allows the factor to view client invoices 636. Based upon predetermined rules such as limiting a maximum credit for each of the clients 640 and overriding this and other financial rules 642, the financial operation may be analyzed via purchase & payment trends 644. Lastly, the preferred embodiment facilitates the vendor participation processing 646. For the vendor participation, a set up unit 648 adds a new vendor and an assignment unit 650 assigns these new vendors to a buyer.

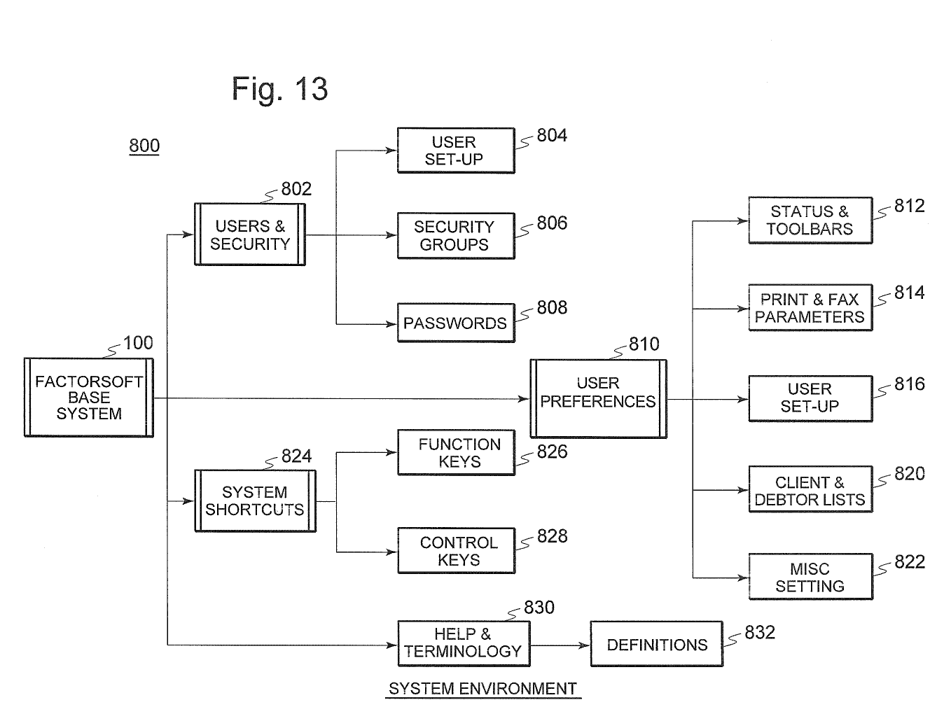

Now referring to FIG. 12, one preferred embodiment using the FactorSoft 100 further includes a report server 702 and a set of templates and preferences 704 to generate various reports on reverse factoring transactions for accounting, analysis, audit and summaries. While the templates define certain predetermined report formats and contents, the preferences define as to how these reports are run including a reporting schedule. For example, the accounting report unit 706 generates various reports A for cash posting, collections, earnings, financials and trial balance. The analysis report unit 710 generates various reports B for client analysis, credit overrides, deferred income, disputes and trend analysis. The audit report unit 714 generates various reports C for client audit, debtor audit, invoice audit and security audit. The miscellaneous report unit 718 generates various reports D for aging, A/R summary, buyout, client reports, credit decision and payment history. In addition, the statements unit 722 generates various reports E for activity, fees, earnings, payouts and volume rebates. Lastly, the vendor summary unit 726 generates reports F for activity accrual summary, activity by region, A/R loan summary, average net funds and balance.

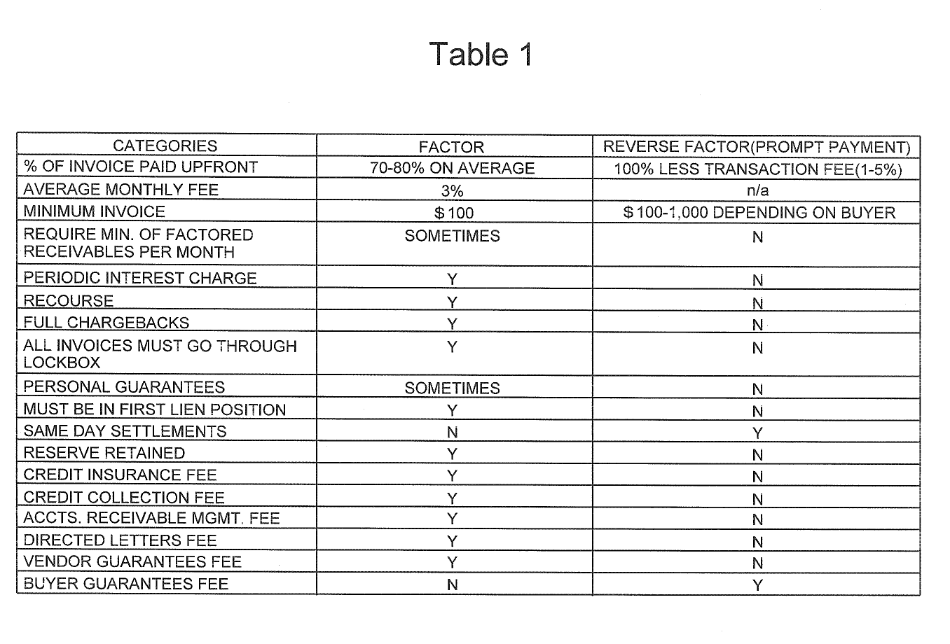

Now referring to FIG. 13, a diagram illustrates certain information for setting the environment for the reverse factoring system for one preferred embodiment using FactorSoft 100 according to the current invention. For users and security environment setting 802, the system environment 800 includes a user set-up 804 for collecting and storing certain information for each user, security groups 806 for defining various groups for access rights and passwords 808 for storing passwords for users and administrators. For user preferences setting 810, the system environment 800 includes a set of preference information for each user to specify status & tool bars 812, print & fax parameters 814, user set-up 816, client & buyer lists 820 and other miscellaneous settings 822. For system short cuts 824, the system environment 800 includes information on function keys 826 and control keys 828. Finally, for help and terminology 830, the system environment 800 includes definitions 832 for providing helpful information.

Currently, FactorSoft allows its users to assign rates only at the supplier level. However, rates are actually assigned at the buyer level and then applied uniformly to all of their vendors. When a vendor has two or more separate buyers, there is the possibility that all will have different transaction fees associated with them. One alternative embodiment would assign one rate, or in this case a group of rates, at the buyer level. Based upon this improvement, the rates would be applied to all vendors under that buyer. Furthermore, the suppliers will be given an incentive by either giving them a “fee reduction” for the more transactions they submit or for the more invoice dollars they submit. In each case, a “fee table” for that buyer is accordingly set using a flag that denotes whether it will be applied by transaction count or dollar amount.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of reverse factoring in invoice payment, comprising the steps of:
i) making an exclusive agreement between a buyer and a factor for offering reverse factoring transactions to all of the buyer's vendors;
ii) soliciting the vendors to participate in the reverse factoring transactions;
iii) paying from the factor to the vendor for invoices at a discount rate on behalf of the buyer if the vendor requests the factor to pay the invoices using the reverse factoring transactions; and
iv) receiving from the buyer a full amount of each of the invoices that the factor has paid in said step iii) on behalf of the buyer.

2. The method of reverse factoring in invoice payment according to claim 1 wherein the exclusive agreement prohibits the buyer from entering into a contractual obligation with a third party who offers reverse factoring services.

3. The method of reverse factoring in invoice payment according to claim 1 further comprising additional steps of:
the vendor generating invoices each specifying a certain amount for services or goods delivered by the vendor to the buyer;
the vendor sending the invoices to the factor and the buyer substantially at the same time; and
upon receiving approval for selected ones of the invoices from the buyer, the factor paying the vendor the approved invoices at a predetermined discount rate.

4. The method of reverse factoring in invoice payment according to claim 3 further comprising an additional step of selecting all of the invoices for the approval.

5. The method of reverse factoring in invoice payment according to claim 3 wherein the factor pays without an external financing source the approved invoices at the predetermined discount rate to the vendor.

6. The method of reverse factoring in invoice payment according to claim 1 wherein the factor receives from the buyer the full amount of each of the invoices that the factor has paid within a predetermined time period.

7. The method of reverse factoring in invoice payment according to claim 1 further comprising additional steps of:
the vendor generating invoices each specifying a certain amount for services or goods delivered by the vendor to the buyer;
the vendor sending the invoices to the factor and the buyer; and
assuming approval of all of the invoices by the buyer, the factor paying the vendor all of the invoices at a predetermined discount rate.

8. A method of reverse factoring in invoice payment, comprising the steps of:
a) a vendor generating invoices each specifying a certain amount for services or goods delivered by the vendor to a buyer;
b) the vendor sending the invoices to a factor and the buyer substantially at the same time;
c) upon receiving approval for selected ones of the invoices from the buyer, the factor paying the vendor the approved invoices at a predetermined discount rate; and
d) the factor receiving from the buyer a full amount of each of the invoices that the factor has paid on behalf of the buyer in said step c).

9. The method of reverse factoring in invoice payment according to claim 8 further comprising additional steps of:
making an exclusive agreement between the buyer and the factor for offering reverse factoring transactions to all of the buyer's vendors prior to said step a); and
soliciting the vendors to participate in the reverse factoring transactions.

10. The method of reverse factoring in invoice payment according to claim 8 wherein the vendor transmits the buyer an electronic interface file containing invoice data for the invoices.

11. The method of reverse factoring in invoice payment according to claim 8 wherein the vendor manually enters information for the invoices via a predetermined Web-site.

12. The method of reverse factoring in invoice payment according to claim 8 wherein the vendor communicates information for the invoices to the factor via any combination of e-mail, fax and telephone.

13. The method of reverse factoring in invoice payment according to claim 8 wherein the buyer transmits the factor an electronic interface file containing invoice approval data for the invoices.

14. The method of reverse factoring in invoice payment according to claim 8 wherein the buyer manually enters invoice approval information for the invoices via a predetermined Web-site.

15. The method of reverse factoring in invoice payment according to claim 8 wherein the buyer selects all of the invoices for the approval.

16. The method of reverse factoring in invoice payment according to claim 8 further comprising an additional step of the buyer denying some of the invoices with a reason.

17. The method of reverse factoring in invoice payment according to claim 8 wherein the factor pays the vendor without using an external financing source the approved invoices at the predetermined discount rate.

18. The method of reverse factoring in invoice payment according to claim 8 wherein the factor updates accounts payable information of the buyer after the factor pays the vendor for the approved invoices.

19. The method of reverse factoring in invoice payment according to claim 8 wherein the factor receives from the buyer the full amount of each of the invoices that the factor has paid within a predetermined time period.

20. The method of reverse factoring in invoice payment according to claim 8 wherein the vendor designate the invoices as normal or expedited in said step b) and the factor pays the vendor the approved invoices at a different time based upon the normal or expedited designation in said step c).

21. The method of reverse factoring in invoice payment according to claim 8 wherein the buyer also performs said steps a) and b) as a vendor to generate a second set of invoices for services or goods delivered by the buyer and the factor also performs said steps c) and d) in response to the second set of the invoices.

22. A method of reverse factoring in invoice payment, comprising the steps of:
A) a vendor generating invoices each specifying a certain amount for services or goods delivered by the vendor to a buyer;
B) the vendor sending the invoices to a factor and the buyer substantially at the same time;
C) the buyer selecting certain ones of the invoices for approval in reverse factoring;
D) the buyer transmitting the factor information on the approved invoices;
E) the factor paying the vendor without an external financing source the approved invoices at a predetermined discount rate; and
F) the factor receiving from the buyer a full amount of each of the invoices that the factor has paid in said step E).

23. The method of reverse factoring in invoice payment according to claim 22 further comprising additional steps of:
making an exclusive agreement between the buyer and the factor for offering reverse factoring transactions to all of the buyer's vendors prior to said step A); and
soliciting the vendors to participate in the reverse factoring transactions.

24. The method of reverse factoring in invoice payment according to claim 22 wherein the vendor transmits an electronic interface file containing invoice data for the invoices in said step B).

25. The method of reverse factoring in invoice payment according to claim 22 wherein the vendor manually enters information for the invoices via a predetermined Web-site in said step B).

26. The method of reverse factoring in invoice payment according to claim 22 wherein the vendor communicates information for the invoices to the factor via any combination of e-mail, fax and telephone in said step B).

27. The method of reverse factoring in invoice payment according to claim 22 wherein the buyer transmits the factor an electronic interface file containing invoice approval data for the invoices in said step D).

28. The method of reverse factoring in invoice payment according to claim 22 wherein the buyer manually enters invoice approval information for the invoices via a predetermined Web-site in said step D).

29. The method of reverse factoring in invoice payment according to claim 22 wherein the buyer selects all of the invoices for the approval in said step C).

30. The method of reverse factoring in invoice payment according to claim 22 further comprising an additional step of the buyer denying some of the invoices with a reason.

31. The method of reverse factoring in invoice payment according to claim 22 wherein the factor updates accounts payable information of the buyer after the factor pays the vendor for the approved invoices in said step E).

32. The method of reverse factoring in invoice payment according to claim 22 wherein the factor receives from the buyer the full amount of each of the invoices that the factor has paid within a predetermined time period in said step F).

33. The method of reverse factoring in invoice payment according to claim 22 wherein the vendor designate the invoices as normal or expedited in said step B) and the factor pays the vendor the approved invoices at a different time based upon the normal or expedited designation in said step E).

34. The method of reverse factoring in invoice payment according to claim 22 wherein the buyer also performs said steps A) and B) as a vendor to generate a second set of invoices for services or goods delivered by the buyer to a third party and the factor also performs said steps E) and F) in response to the second set of the invoices, the third party performing said steps C) and D) as a buyer.

35. A method of reverse factoring in invoice payment, comprising the steps of:
a) a vendor generating invoices each specifying a certain amount for services or goods delivered by the vendor to a buyer;
b) the vendor sending the invoices to a factor and the buyer;
c) assuming approval of all of the invoices by the buyer, the factor paying the vendor all of the invoices at a predetermined discount rate; and
d) the factor receiving from the buyer a full amount of each of the invoices that the factor has paid on behalf of the buyer in said step c).

36. A method of reverse factoring in invoice payment, comprising the steps of:
a) a vendor generating invoices each specifying a certain amount for services or goods delivered by the vendor to a buyer;
b) the vendor sending the invoices to the buyer only;
c) upon receiving approval for selected ones of the invoices from the buyer, a factor paying the vendor the approved invoices at a predetermined discount rate; and
d) the factor receiving from the buyer a full amount of each of the invoices that the factor has paid on behalf of the buyer in said step c).

37. A system for reverse factoring in invoice payment, comprising:
a vendor system for generating invoice data for invoices and transmitting the invoice data;
a buyer system connected to said vendor system for receiving the invoice data and processing the invoice data to generate payment approval data indicating approval of the invoices to be paid, said buyer system maintaining accounts payable based upon the invoices; and
a factor system connected to said vendor system and said buyer system for receiving the invoice data from said vendor system and the payment approval data from said buyer system, said factor system selecting the invoices based upon the payment approval data for generating and transmitting payment instructions at a predetermined discount rate, said factor system updating information on a payee and a due date in the accounts payable of said buyer system upon confirming a payment according to the payment instructions.

38. The system for reverse factoring in invoice payment according to claim 37 wherein said vendor system transmits the invoice data to said buyer system and the factor system substantially at the same time.

39. The system for reverse factoring in invoice payment according to claim 37 wherein said vendor system transmits said buyer system an electronic interface file containing invoice data for the invoices in a predetermined format.

40. The system for reverse factoring in invoice payment according to claim 37 wherein said factor system provides an interface via a predetermined Web-site for manually entering information for the invoices.

41. The system for reverse factoring in invoice payment according to claim 37 wherein said buyer system transmits said factor system an electronic interface file containing payment approval data for the invoices in a predetermined format.

42. The system for reverse factoring in invoice payment according to claim 37 wherein said factor system provides an interface via a predetermined Web-site for manually entering payment approval information for the invoices.

43. The system for reverse factoring in invoice payment according to claim 37 wherein said factor system transmits a reminder to said buyer system for a pending unprocessed portion of the invoice data after a predetermined amount of time.

44. The system for reverse factoring in invoice payment according to claim 37 wherein said buyer system processes the invoice data to generate payment rejection data indicating denied payment of the invoices and an associated reason, said buyer system transmitting the payment rejection data to said factor's system.

45. A system for reverse factoring in invoice payment, comprising:
a vendor system for generating the invoice data for invoices;
a buyer system connected to said vendor system for receiving the invoice data and processing the invoice data to generate payment approval data indicating approval of the invoices to be paid, said buyer system maintaining accounts payable based upon the invoices; and
a factor system connected to said vendor system and said buyer system for receiving the invoice data from said vendor system and the payment approval data from said buyer system, said factor system selecting the invoices based upon the payment approval data for generating and transmitting payment instructions at a predetermined discount rate, said vendor system transmitting the invoice data to said buyer system and said factor system substantially at the same time.

46. The system for reverse factoring in invoice payment according to claim 45 wherein said factor system updates information on a payee and a due date in the accounts payable of said buyer system upon confirming a payment according to the payment instructions.

47. The system for reverse factoring in invoice payment according to claim 45 wherein said vendor system transmits said buyer system an electronic interface file containing invoice data for the invoices in a predetermined format.

48. The system for reverse factoring in invoice payment according to claim 45 wherein said factor system provides an interface via a predetermined Web-site for manually entering information for the invoices.

49. The system for reverse factoring in invoice payment according to claim 45 wherein said buyer system transmits said factor system an electronic interface file containing payment approval data for the invoices in a predetermined format.

50. The system for reverse factoring in invoice payment according to claim 45 wherein said factor system provides an interface via a predetermined Web-site for manually entering payment approval information for the invoices.

51. The system for reverse factoring in invoice payment according to claim 45 wherein said factor system transmits a reminder to said buyer system for a pending unprocessed portion of the invoice data after a predetermined amount of time.

52. The system for reverse factoring in invoice payment according to claim 45 wherein said buyer system processes the invoice data to generate payment rejection data indicating denied payment of the invoices and an associated reason, said buyer system transmitting the payment rejection data to said factor's system.
